(19) United States
(12) Patent Application Publication
(10) Pub. No.: US 2014/0234754 A1
(43) Pub. Date: Aug. 21, 2014

(54) FUEL CELL SEPARATOR SEALING MATERIAL

(71) Applicants: Shin-Etsu Chemical Co., Ltd., Tokyo (JP); HONDA MOTOR CO., LTD., Tokyo (JP)

(72) Inventors: Satoru TERADA, Wako-shi (JP); Daisuke OKONOGI, Wako-shi (JP); Masakatsu HOTTA, Annaka-shi (JP)

(73) Assignees: Shin-Etsu Chemical Co., Ltd., Tokyo (JP); HONDA MOTOR CO., LTD., Tokyo (JP)

(21) Appl. No.: 14/175,338

(22) Filed: Feb. 7, 2014

(30) Foreign Application Priority Data
Feb. 20, 2013 (JP) 2013-031111

(51) Int. Cl. H01M 8/02

(52) U.S. Cl. CPC H01M 8/0228
USPC 429/510

(57) ABSTRACT

In a fuel cell separator comprising a separator substrate, a first primer layer, a second primer layer, and an elastomeric seal layer, the first primer layer is formed by firing an organometallic compound, the second primer layer is formed by firing an organosilicon compound having a Si—H group, and the elastomeric seal layer is formed by curing a liquid addition-curable silicone rubber composition comprising an alkenyl-containing base polymer and an Si—H group-containing crosslinker.

### CROSS-REFERENCE TO RELATED APPLICATION

This non-provisional application claims priority under 35 U.S.C. §119(a) on Patent Application No. 2013-031111 filed in Japan on Feb. 20, 2013, the entire contents of which are hereby incorporated by reference.

### TECHNICAL FIELD

This invention relates to separators of polymer electrolyte fuel cells (PEFC) featuring compactness and more particularly, to sealing materials for use in separators of PEFC which have sufficient acid resistance to ensure a long service life.

### BACKGROUND ART

Currently great efforts are made on polymer electrolyte fuel cells (PEFC) as the replacement power source for internal combustion engines on vehicles. The PEFC is constructed of electrolyte membranes, separators and other components. The separator is generally a plate which is provided with a plurality of juxtaposed channels on one surface or both surfaces. The separator plays the role of conducting the electricity produced at the gas diffusion electrode within the fuel cell to the exterior, discharging water produced within the channels in the course of electricity generation, and securing the channels as a flow path for incoming reaction gas to the fuel cell. Such a fuel cell separator is required to be more compact in size. Since a multiplicity of separators are used in stack, there is a demand for a separator seal material having durability and long term service.

The study of elastomeric sealing material puts an interest on silicone rubber obtained by curing a liquid addition-curable silicone rubber composition featuring ease of molding. The sealing material is improved in acid resistance by adding silicone resins or the like, as described in Patent Document 1. However, the problem of adhesion between the substrate and the elastomeric sealing material in acidic solution remains unsolved, with efforts being made on the development of various primers.

Patent Document 2 describes a primer composition comprising a compound having at least one epoxy group, at least one Si—H group, and at least one aromatic ring in the molecule, a silicone resin, and an alkenyl-containing compound, the composition having high acid resistance. Patent Document 3 discloses an elastomeric sealing material having an optimum molar ratio of Si—H groups to alkenyl groups. Patent Document 4 describes a primer composition comprising an alkoxysilane, an organotitanium compound, and polyorganohydrogensiloxane (Si—H group).

Further, Patent Document 5 proposes a method of providing an alloy substrate with corrosion resistance to chloride aqueous solution. An organosilicon polymer having Si—H groups and carbon-carbon multiple bonds is mixed with a metal alkoxide containing titanium or tantalum, and the mixture is fired. In Patent Document 6, a primer composition comprising a copolymeric oligomer of an amino-containing alkoxysilane and a vinyl-containing alkoxysilane and an organometallic compound is proposed as the primer for improving the water-resistant adhesion of an integrated stainless steel/rubber article.

### CITATION LIST

Patent Document 1: JP-A 2002-309092 (U.S. Pat. No. 7,482,403)
Patent Document 2: JP-A 2007-146147
Patent Document 3: JP-A 2009-231272 (US 20090220849)
Patent Document 4: JP-A 2004-103290
Patent Document 5: JP 4071091
Patent Document 6: JP-A 2004-026848

### DISCLOSURE OF INVENTION

In these acid resistant primers disclosed in the cited patent documents, an Si—H group-containing compound or alkoxysilane is essential, with which a minor amount of an organometallic compound is optionally mixed. Empirically, the inventors confirmed that when a primer layer containing an Si—H group-containing compound or alkoxysilane is directly coated and fired to a metal substrate, typically stainless steel substrate, sufficient acid resistance, especially durability to sulfuric acid acidity is not available.

Accordingly, an object of the invention is to provide a polymer electrolyte fuel cell using the specific sealing material which has improved seal performance and acid resistance.

The inventors have found that when an elastomeric seal layer is joined to a substrate, better adhesion is achievable from the following provisions. That is, two primer layers are interposed, the first primer layer lying contiguous to the substrate surface is obtained by firing an organometallic compound, and the second primer layer lying on the first primer layer is obtained by firing an organosilicon compound having a Si—H group. The elastomeric seal layer lying on the second primer layer is obtained by curing a liquid addition-curable silicone rubber composition comprising a base polymer containing silicon-bonded alkenyl groups and a crosslinker containing silicon-bonded hydrogen (i.e., Si—H functional groups). The resulting sealing material maintains satisfactory seal performance and adhesion in an acidic solution over a long term. The invention is predicated on this finding.

The invention provides a fuel cell separator comprising a separator substrate, a first primer layer, a second primer layer, and an elastomeric seal layer stacked in the described order, wherein the first primer layer is formed by firing an organometallic compound, the second primer layer is formed by firing an organosilicon compound having a Si—H group, and the elastomeric seal layer is a cured layer of a liquid addition-curable silicone rubber composition containing alkenyl groups and Si—H functional groups.

In a preferred embodiment, the organometallic compound is an organotitanium or organozirconium compound. More preferably the organotitanium or organozirconium compound has at least one chelate ring or at least one alkoxy group or both.

Most often, the substrate is made of stainless steel.

### ADVANTAGEOUS EFFECTS OF INVENTION

When the sealing material is used in a fuel cell separator, it establishes a tight bond between the separator substrate and the elastomeric seal layer and maintains a good seal performance and tight bond even in an acidic solution over a long term.

### DESCRIPTION OF EMBODIMENTS

The sealing material of the invention is characterized in that first and second primer layers are interposed between a substrate and an elastomeric seal layer, a fired layer of an organometallic compound is provided as the first primer layer on the substrate surface, and a fired layer of an organosilicon compound having an Si—H group is laid or laminated as the second primer layer on the first primer layer.

When a silicon compound is directly bonded to the substrate, the resulting silicon compound layer has insufficient acid resistance. If more silicon compound/fired organometallic layer/substrate bonds are available than silicon compound/substrate bonds, acid resistance would be improved, although the number of steps of coating and firing primers is increased.

The substrate used herein is typically a metal substrate, preferably stainless steel substrate. When two primer layers are formed on the metal substrate, preferably stainless steel substrate according to the invention, they exert excellent adhesion and acid resistance on the metal substrate.

The first primer layer is formed by firing an organometallic compound. The organometallic compound used herein is one or more organotitanium compounds or organozirconium compounds or a combination thereof. Preferably the organometallic compound has at least one chelate ring or at least one alkoxy group, or both.

Examples of the organotitanium compound include tetraisopropoxytitanium, tetra-n-butoxytitanium, tetra-2-ethylhexyl titanate, diisopropoxytitanium bisacetylacetonate, and diisopropoxytitanium bisethylacetoacetonate. Examples of the organozirconium compound include tetra-n-propoxyzirconium, tetra-n-butoxyzirconium, zirconium tetraacetylacetonate, tri-n-butoxyzirconium monoacetylacetonate, and di-n-butoxyzirconium diethylacetoacetonate.

On use, the organometallic compound is preferably diluted with an organic solvent to form a solution having a concentration of 1 to 30%, more preferably 5 to 15% by weight, which is coated to form the first primer layer. Suitable organic solvents include hydrocarbons such as hexane, heptane, toluene and xylene, alcohols such as methanol, ethanol, isopropanol, and 2-ethoxyethanol, and ketones such as acetone, methyl ethyl ketone and methyl isobutyl ketone, which may be used alone or in admixture.

The organometallic compound solution may be applied by any coating methods such as brush coating, spray coating, dip coating, screen printing and inkjet printing. The coating is preferably dried at room temperature or with hot air and fired at 100 to 400° C. for 0.5 to 2 hours. The resulting primer layer of organometallic compound preferably has a thickness of 0.01 to 10 μm, more preferably 0.05 to 3 μm. The first primer layer with a thickness of less than 0.01 μm may not exert its own function whereas the primer layer with a thickness in excess of 10 μm may have weak adhesion to the substrate.

The second primer layer is formed by firing an organosilicon compound having a Si—H group. The organosilicon compound used herein must have a Si—H group, i.e., silicon-bonded hydrogen and is typically selected from silane compounds and siloxane compounds such as organohydrogensilanes and organohydrogenpolysiloxanes. Preferred are those organosilicon compounds further having at least one functional group selected from among epoxy, aromatic ring (e.g., multivalent aromatic ring such as di- to tetravalent phenylene structure), alkenyl and alkoxysilyl in a common molecule, as described in Patent Document 2 (JP-A 2007-146147). Typical are organopolysiloxanes having at least one Si—H group, at least one multivalent aromatic ring, and at least one epoxy group in a molecule.

In the second primer layer, another organosilicon compound such as a silane coupling agent and/or silicone resin may be added as an optional active component. Suitable silane coupling agents include alkoxysilanes having a functional group such as alkenyl, epoxy, (meth)acryloxy, amino, mercapto or ureido, and partial hydrolytic condensates thereof.

Suitable silicone resins are organopolysiloxane resins of branched or three-dimensional network structure containing trifunctional siloxane units and/or SiO_{4/2} units. The silane coupling agent and silicone resin may be typically added in an amount of up to 70% by weight, specifically 0 to 70% by weight, preferably 1 to 50% by weight based on the active components (exclusive of organic solvent) in the second primer layer.

On use of active components (i.e., all organosilicon compounds as essential and optional components) in the second primer layer, organosilicon compounds including the Si—H group-containing organosilicon compound are diluted with an organic solvent which is typically selected from hydrocarbons, alcohols and ketones. The content of Si—H functional groups is preferably 0.1 to 15 mmol/g, more preferably 1 to 15 mmol/g of the active components exclusive of the solvent.

Like the organometallic compound, the second primer solution may be applied onto the surface of the first primer layer by any coating methods such as brush coating, spray coating, dip coating, screen printing and inkjet printing. The coating is preferably dried at room temperature or with hot air and fired at 100 to 250° C. for 0.5 to 2 hours. The resulting primer layer of organosilicon compounds preferably has a thickness of 0.01 to 10 μm, more preferably 0.1 to 5 μm. The second primer layer with a thickness of less than 0.01 μm may not exert its own function whereas the primer layer with a thickness in excess of 10 μm may have poor acid resistance.

On the first and second primer layers deposited on the substrate surface, the elastomeric seal layer is deposited or laminated. The elastomeric seal layer is not particularly limited as long as it is formed by curing a liquid addition-curable silicone rubber composition which contains alkenyl groups and Si—H functional groups and is self-flowing at room temperature (25° C.). Preferred is a liquid addition-curable silicone rubber composition comprising (A) 100 parts by weight of an organopolysiloxane containing at least two silicon-bonded alkenyl groups in a molecule, (B) 0.5 to 20 parts by weight of an organohydrogenpolysiloxane containing at least three silicon-bonded hydrogen atoms (i.e., Si—H functional groups) in a molecule, (C) 5 to 30 parts by weight of fumed silica having a specific surface area of 50 to 400 m²/g, and (D) a catalytic amount of an addition reaction catalyst.

Component (A) is an organopolysiloxane containing at least two alkenyl groups each attached to a silicon atom in a molecule. It is a base polymer of which the elastomeric seal layer or cured silicone rubber is constructed. Most often, it is represented by the following average compositional formula (I):

R¹ₐSiO_{(4-a)/2} (I)

wherein R¹ which may be the same or different is a substituted or unsubstituted monovalent hydrocarbon group having 1 to 10 carbon atoms, preferably 1 to 8 carbon atoms, and “a” is a positive number in the range of 1.5 to 2.8, preferably 1.8 to 2.5, and more preferably 1.95 to 2.05.

Examples of the substituted or unsubstituted monovalent hydrocarbon group represented by R¹ include alkyl groups such as methyl, ethyl, propyl, isopropyl, butyl, isobutyl, tert-butyl, pentyl, neopentyl, hexyl, cyclohexyl, octyl, nonyl, and decyl; aryl groups such as phenyl, tolyl, xylyl and naphthyl; aralkyl groups such as benzyl, phenylethyl and phenylpropyl; alkenyl groups such as vinyl, allyl, propenyl, isopropenyl, butenyl, hexenyl, cyclohexenyl and octenyl, as well as substituted forms of the foregoing groups in which some or all hydrogen atoms are replaced by halogen atoms (e.g., fluoro, bromo and chloro), cyano groups or the like, such as chloromethyl, chloropropyl, bromoethyl, trifluoropropyl and cyanoethyl. Preferably, at least 90 mol % of the entire R¹ are methyl.

At least two of R¹ should be alkenyl groups, preferably of 2 to 8 carbon atoms, more preferably 2 to 6 carbon atoms, and most preferably vinyl. The content of alkenyl groups is preferably 5.0×10⁻⁶ mol/g to 5.0×10⁻³ mol/g, more preferably 1.0×10⁻⁵ mol/g to 1.0×10⁻³ mol/g of the organopolysiloxane. An alkenyl content of less than 5.0×10⁻⁶ mol/g may give too low a rubber hardness to provide a satisfactory seal whereas an alkenyl content of more than 5.0×10⁻³ mol/g may result in a higher crosslinked density and hence, brittle rubber.

The alkenyl group may be attached to a silicon atom at the end of the molecular chain or a silicon atom midway the molecular chain or both. The inclusion of at least alkenyl groups attached to silicon atoms at both ends of the molecular chain is preferred.

The preferred organopolysiloxane basically has a linear structure, but may partially have a branched, cyclic or three-dimensional network structure. With respect to the molecular weight, the organopolysiloxane is not particularly limited and may include a wide spectrum ranging from liquid one having a low viscosity to gum-like one having a high viscosity at room temperature (25° C.). The preferred organopolysiloxane has a DOP (weight average degree of polymerization) of 100 to 2,000, and more preferably 150 to 1,500. If the DOP is less than 100, a cured silicone rubber may have an insufficient elasticity to provide a seal. If the DOP exceeds 2,000, a silicone rubber composition may become too viscous to mold. Where the organopolysiloxane has a three-dimensional network structure, it preferably has a weight average molecular weight (Mw) of up to 100,000, specifically 3,000 to 100,000, more preferably 5,000 to 50,000, for the same reasons as above. It is noted that the DOP or Mw may be determined versus polystyrene standards from a degree-of-polymerization distribution or molecular weight distribution as measured by gel permeation chromatography (GPC) using toluene as developing solvent.

Component (B) is an organohydrogenpolysiloxane containing at least three hydrogen atoms each attached to a silicon atom (i.e., Si—H groups) in a molecule. It serves as a crosslinking agent for curing the composition wherein Si—H groups in the molecule crosslink with silicon-bonded alkenyl groups in component (A) through hydrosilylating addition reaction.

Most often, the organohydrogenpolysiloxane (B) is represented by the following average compositional formula (II):

R²_{b}H_{c}SiO_{(4-b-c)/2} (II)

wherein R² is each independently an unsubstituted or halo-substituted monovalent hydrocarbon group having 1 to 10 carbon atoms, preferably 1 to 8 carbon atoms, “b” is a positive number of 0.7 to 2.1, “c” is a positive number of 0.001 to 1.0, and b+c is from 0.8 to 3.0. Preferred are those of formula (II) having at least three, specifically 3 to 300, more preferably 3 to 100, and most preferably 3 to 50 silicon-bonded hydrogen atoms (i.e., Si—H groups) in a molecule.

Examples of the optionally halogenated monovalent hydrocarbon group represented by R² are as exemplified above for R¹ although groups free of aliphatic unsaturation (as in alkenyl groups) are preferred. Preferably, “b” is 0.8 to 2.0, “c” is 0.01 to 1.0, and b+c is from 1.0 to 2.5.

Typically the organohydrogenpolysiloxane (B) is free of any functional group (e.g., alkenyl, epoxy or polyvalent aromatic ring such as phenylene) other than the Si—H group. The molecular structure of the organohydrogenpolysiloxane may be linear, cyclic, branched or three-dimensional network. The number of silicon atoms per molecule or the degree of polymerization is preferably about 2 to about 300, especially about 4 to about 150. Differently stated, the preferred organohydrogenpolysiloxanes are those which are liquid at room temperature (25° C.) and specifically have a viscosity of up to 1,000 mPa·s, and more preferably 0.1 to 500 mPa·s at 25° C. The hydrogen atom may be attached to a silicon atom at the end of the molecular chain or a silicon atom midway the molecular chain or both.

Exemplary of the organohydrogenpolysiloxane (B) are trimethylsiloxy-terminated methylhydrogenpolysiloxane, trimethylsiloxy-terminated dimethylsiloxane-methylhydrogensiloxane copolymers, dimethylhydrogensiloxy-terminated dimethylpolysiloxane, dimethylhydrogensiloxy-terminated dimethylsiloxane-methylhydrogensiloxane copolymers, trimethylsiloxy-terminated methylhydrogensiloxane-diphenylsiloxane copolymers, trimethylsiloxy-terminated methylhydrogensiloxane-diphenylsiloxane-dimethylsiloxane copolymers, copolymers composed of (CH₃)₂HSiO_{1/2} units and SiO_{4/2} units, and copolymers composed of (CH₃)₂HSiO_{1/2} units, SiO_{4/2} units and (C₆H₅)SiO_{3/2} units. As used herein, the term “terminated” means that the polysiloxane is capped at both ends of its molecular chain with the indicated groups.

The amount of the organohydrogenpolysiloxane (B) blended is 0.5 to 20 parts, and preferably 0.6 to 15 parts by weight, per 100 parts by weight of component (A). The molar ratio of silicon-bonded hydrogen atoms (Si—H functional groups) in component (B) to alkenyl groups in component (A), [Si—H/alkenyl], is preferably from 0.8:1 to 3.0:1, especially from 1.0:1 to 1.5:1. A molar ratio outside this range may lead to cured rubber with increased compression set, aggravating the seal performance.

Component (C) is fumed silica which is essential to impart satisfactory strength to silicone rubber. The fumed silica should have a specific surface area of 50 to 400 m²/g, and preferably 100 to 350 m²/g, as measured by the BET method. A surface area below 50 m²/g may compromise acid resistance whereas above 400 m²/g, compression set increases. The fumed silica may be used as such, but preferably after treatment with a surface hydrophobizing agent. Alternatively, a surface treating agent is added when the fumed silica is mixed with the silicone fluid, whereby the fumed silica is treated during the mixing step. Suitable surface treating agents are well-known agents including alkylalkoxysilanes, alkylchlorosilanes, alkylsilazanes, silane coupling agents, titanate treating agents, and fatty acid esters alone or in admixture. When two or more agents are used, they may be applied at the same time or different times.

The amount of fumed silica (C) blended is 5 to 30 parts, preferably 10 to 30 parts, and more preferably 12 to 28 parts by weight, per 100 parts by weight of component (A). Less than 5 parts of fumed silica fails to provide satisfactory rubber strength whereas more than 30 parts increases compression set, aggravating the seal performance.

Component (D) is an addition reaction catalyst for promoting addition reaction between alkenyl groups in the organopolysiloxane as component (A) and silicon-bonded hydrogen atoms (Si—H groups) in the organohydrogenpolysiloxane as component (B). Most often, the catalyst is selected from platinum group metal-based catalysts including platinum catalysts such as platinum black, platinic chloride, chloroplatinic acid, reaction products of chloroplatinic acid with monohydric alcohols, complexes of chloroplatinic acid with olefins, and platinum bisacetoacetate as well as palladium catalysts and rhodium catalysts, with the platinum catalysts being preferred.

The amount of the catalyst blended is a catalytic amount to promote addition reaction and usually about 0.5 to 1,000 ppm, especially about 1 to 500 ppm of platinum group metal based on the weight of component (A). Less than 0.5 ppm may be ineffective to promote addition reaction, leading to undercure. Amounts of more than 1,000 ppm may exert little further effect on reactivity and be uneconomical.

If necessary, the composition may further contain other components, for example, reinforcing agents such as precipitated silica and silicone resins; fillers such as ground quartz, diatomaceous earth and calcium carbonate; hydrosilylation reaction regulating agents such as nitrogen-containing compounds, acetylene compounds, phosphorus compounds, nitrile compounds, carboxylates, tin compounds, mercury compounds, and sulfur compounds; heat resistance improvers such as iron oxide and cerium oxide; internal parting agents such as dimethylsilicone fluid; tackifiers, and thixotropic agents.

The silicone rubber composition may be prepared by mixing components (A) to (D) and optional components until uniform. Typically the composition may have a viscosity of 20 to 5,000 Pa·s, preferably 30 to 1,000 Pa·s at room temperature (25° C.), as measured by a rotational viscometer.

The elastomeric seal layer is formed of the addition reaction cure type silicone rubber composition in the cured state. The silicone rubber composition may be applied and cured by well-known techniques, forming a seal on a PEFC separator.

As the method of curing and shaping the silicone rubber composition on the second and first primer layers on the substrate, an insert shaping method by compression, transfer or injection molding or a screen printing method may be used to form an elastomeric seal layer of silicone rubber on the second primer layer.

During the step of curing and shaping the silicone rubber composition, the cure temperature may vary from room temperature (25° C.) to elevated temperature. Typically the silicone rubber composition is cured and shaped by heating at 100 to 220° C. for 10 seconds to 2 hours, preferably at 120 to 200° C. for 20 seconds to 30 minutes. Once the silicone rubber composition is cured and shaped (i.e., primary cure), post-cure (i.e., secondary cure) may be carried out for the purposes of improving the adhesion and compression set of the cured composition. Typical post-cure conditions include a temperature of 100 to 220° C. and a time of 30 minutes to 100 hours, preferably 120 to 200° C. and 1 to 8 hours.

The elastomeric seal layer obtained by curing and shaping the silicone rubber composition typically has a thickness of about 50 to 5,000 μm, preferably about 100 to 1,000 μm.

### Example

Examples and Comparative Examples are given below for further illustrating the invention, but the invention is not limited thereto. All parts are by weight.

### Metal Substrate

Metal substrates (stainless steel SUS316) of 10 mm×100 mm×0.1 mm (thick) were prepared and surface cleaned with toluene.

### First Primer Layer

To 100 parts of an organotitanium compound (Examples 1 to 3) or organozirconium compound (Examples 4 to 6), both commercially available from Matsumoto Fine Chemical Co., Ltd., was added 900 parts of methyl ethyl ketone as organic solvent. The solution was brush coated onto the metal substrate, held at room temperature (25° C.) for 30 minutes, and fired at 180° C. for 1 hour, forming a first primer layer of about 1 μm thick on the substrate surface.

### Second Primer Layer

A coating liquid was prepared by mixing 40 parts of an organopolysiloxane containing Si—H groups, polyvalent aromatic rings and epoxy groups in a molecule, shown below, as component (1), 40 parts of a silicone resin, shown below, as component (2), and 20 parts of γ-glycidoxypropyltrimethylsilane as silane coupling agent with 100 parts of methyl ethyl ketone as organic solvent. The liquid was brush coated onto the primed metal substrate, held at room temperature (25° C.) for 30 minutes, and fired at 180° C. for 1 hour, forming a second primer layer of about 3 μm thick on the first primer layer.

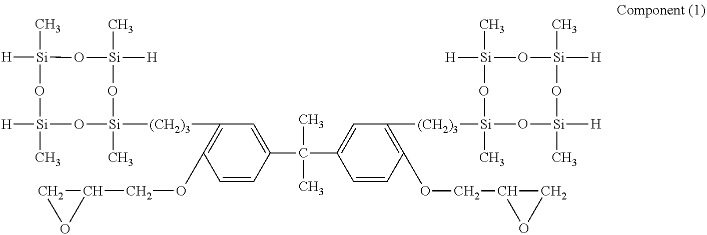

### Component (2): Silicone Resin

A copolymer consisting of C₆H₅SiO_{3/2} units, CH₃SiO_{3/2} units and (CH₃)₂SiO_{2/2} units, wherein a phenyl content is 40 mol % based on the total of phenyl and methyl groups, an OH group content is 2.5% by weight, a ratio of C₆H₅SiO_{3/2} and CH₃SiO_{3/2} units to the overall siloxane units is 40 mol %, the copolymer having a Mw of 3,600 as determined versus polystyrene standards from a molecular weight distribution by GPC analysis.

### Composite Primer Layer

The organotitanium or organozirconium compound, 10 parts, was added to 100 parts of the second primer layer coating liquid, yielding a composite primer coating liquid containing both the organometallic compound and organosilicon compound. The liquid was brush coated onto the metal substrate, held at room temperature (25° C.) for 30 minutes, and fired at 180° C. for 1 hour, forming a composite primer layer of about 3 μm thick on the metal substrate surface.

### Silicone Rubber Layer

Dimethylvinylsiloxy-terminated dimethylpolysiloxane having a DOP of 300, 80 parts, was mixed with 22 parts of fumed silica having a specific surface area of 300 m²/g (Aerosil 300 by Nippon Aerosil Co., Ltd.), 5 parts of hexamethyldisilazane, 0.2 part of divinyltetramethyldisilazane, and 2.0 parts of water at room temperature for 30 minutes. The mixture was heated at 150° C., agitated at the temperature for 3 hours, and cooled. The mixture was further combined with 20 parts of trimethylsiloxy-terminated dimethylpolysiloxane containing vinyl on side chains (DOP=150, vinyl content=0.00041 mol/g), and milled one pass on a three-roll mill, yielding a silicone rubber base. To 122 parts of the silicone rubber base were added 3.7 parts (giving [Si—H/alkenyl]=1.8) of a methylhydrogenpolysiloxane containing Si—H groups at both ends and on side chains (DOP=32, a Si—H content=0.0066 mol/g) as a crosslinker and 0.05 part of ethynyl cyclohexanol as a reaction regulator. The mixture was agitated for 15 minutes and further mixed with 0.1 part of a platinum catalyst (Pt concentration 1 wt %), yielding a silicone rubber composition which was liquid at room temperature.

### Bond Test

On the primed metal substrate (specifically the second primer layer on the first primer layer, or the composite primer layer), the silicone rubber composition was press molded at 150° C. for 3 minutes to form a silicone rubber layer of 0.3 mm thick on the primed substrate. This was followed by post-cure in an oven at 200° C. for 2 hours.

The molded part in which rubber was integrated to substrate was examined for bond state by a peeling test initially and after an acid test of immersing the part in sulfuric acid solution (pH 2) at 95° C.

### Results

The samples having the first and second primer layers deposited thereon maintained satisfactory bond state even after 500 hours of the acid test. The peeling test of peeling the rubber layer from the substrate resulted in 100% cohesive failure (CF).

The samples having the second primer layer (without the first primer layer) showed satisfactory bond state initially and after 100 hours of the acid test, but allowed overall peel to occur at the interface between the metal substrate and the primer layer after 500 hours of the acid test.

Similarly, the samples having the composite primer layer allowed overall peel to occur after 500 hours of the acid test.

TABLE 1

| | | Example 1 | Example 2 | Example 3 |
|---|---|---|---|---|
| 1st primer layer | | formed | formed | formed |
| | | tetraiso- | tetra-2- | diisopropoxy- |
| | | propoxytitanium | ethylhexyl | titanium |
| | | | titanate | bisethylaceto- |
| | | | | acetonate |
| 2nd primer layer | | formed | formed | formed |
| Bond | Initial | 100% CF | 100% CF | 100% CF |
| state | After 100 hr | 100% CF | 100% CF | 100% CF |
| | acid test | | | |
| | After 500 hr | 100% CF | 100% CF | 100% CF |
| | acid test | | | |

TABLE 2

| | | Example 4 | Example 5 | Example 6 |
|---|---|---|---|---|
| 1st primer layer | | formed | formed | formed |
| | | tetra-n- | zirconium | di-n-butoxy- |
| | | butoxyzirconium | tetraacetyl- | zirconium |
| | | | acetonate | diethylaceto- |
| | | | | acetonate |
| 2nd primer layer | | formed | formed | formed |
| Bond | Initial | 100% CF | 100% CF | 100% CF |
| state | After 100 hr | 100% CF | 100% CF | 100% CF |
| | acid test | | | |
| | After 500 hr | 100% CF | 100% CF | 100% CF |
| | acid test | | | |

TABLE 3

| | | Comparative | Comparative | Comparative |
|---|---|---|---|---|
| | | Example 1 | Example 2 | Example 3 |
| 1st primer layer | | nil | nil | nil |
| 2nd primer layer | | formed | nil | nil |
| Composite primer | | nil | formed | formed |
| layer | | | tetra-2- | tetra-n-butoxy- |
| | | | ethylhexyl | zirconium |
| | | | titanate | |
| Bond | Initial | 100% CF | 100% CF | 100% CF |
| state | After 100 hr | 100% CF | 100% CF | 100% CF |
| | acid test | | | |
| | After 500 hr | overall peel | overall peel | overall peel |
| | acid test | | | |

Japanese Patent Application No. 2013-031111 is incorporated herein by reference.

Although some preferred embodiments have been described, many modifications and variations may be made thereto in light of the above teachings. It is therefore to be understood that the invention may be practiced otherwise than as specifically described without departing from the scope of the appended claims.

1. A fuel cell separator comprising a separator substrate, a first primer layer, a second primer layer, and an elastomeric seal layer stacked in the described order, wherein
the first primer layer is formed by firing an organometallic compound,
the second primer layer is formed by firing an organosilicon compound having a Si—H group, and
the elastomeric seal layer is a cured layer of a liquid addition-curable silicone rubber composition containing alkenyl groups and Si—H functional groups.

2. The fuel cell separator of claim 1 wherein the organometallic compound is an organotitanium or organozirconium compound.

3. The fuel cell separator of claim 2 wherein the organotitanium or organozirconium compound has at least one chelate ring or alkoxy group or both.

4. The fuel cell separator of claim 3 wherein the organotitanium or organozirconium compound is at least one selected from the group consisting of tetraisopropoxytitanium, tetra-n-butoxytitanium, tetra-2-ethylhexyl titanate, diisopropoxytitanium bisacetylacetonate, diisopropoxytitanium bisethylacetoacetonate, tetra-n-propoxyzirconium, tetra-n-butoxyzirconium, zirconium tetraacetylacetonate, tri-n-butoxyzirconium monoacetylacetonate, and di-n-butoxyzirconium diethylacetoacetonate.

5. The fuel cell separator of claim 1 wherein the organosilicon compound has a Si—H group and at least one functional group selected from the group consisting of epoxy, aromatic ring, alkenyl and alkoxysilyl.

6. The fuel cell separator of claim 1 wherein the organosilicon compound is an organopolysiloxane having at least one Si—H group, at least one multivalent aromatic ring, and at least one epoxy group in a molecule.

7. The fuel cell separator of claim 1 wherein the second primer layer is formed by firing an organosilicon compound having a Si—H group, and a silane coupling agent and/or silicone resin.

8. The fuel cell separator of claim 1 wherein the liquid addition-curable silicone rubber composition comprises (A) 100 parts by weight of an organopolysiloxane containing at least two silicon-bonded alkenyl groups in a molecule, (B) 0.5 to 20 parts by weight of an organohydrogenpolysiloxane containing at least three silicon-bonded hydrogen atoms (i.e., Si—H functional groups) in a molecule, (C) 5 to 30 parts by weight of fumed silica having a specific surface area of 50 to 400 m²/g, and (D) a catalytic amount of an addition reaction catalyst.

9. The fuel cell separator of claim 1 wherein the substrate is made of stainless steel.
